(19) United States
(12) Patent Application Publication
(10) Pub. No.: US 2014/0366043 A1
(43) Pub. Date: Dec. 11, 2014

(54) METHOD FOR INVOKING PROGRAM AND ELECTRONIC DEVICE THEREOF

(71) Applicant: Samsung Electronics Co., Ltd., Suwon-si (KR)

(72) Inventors: Bo Zhu, Beijing (CH); Zhuang Liu, Beijing (CH)

(21) Appl. No.: 14/296,916

(22) Filed: Jun. 5, 2014

(30) Foreign Application Priority Data
Jun. 7, 2013 (CH) 201310225900.1

(51) Int. Cl. G06F 9/54; G06F 3/0481

(52) U.S. Cl. CPC G06F 9/542; G06F 3/0481
USPC 719/318

(57) ABSTRACT

A method, an apparatus and a terminal device for invoking a program are provided. The method includes detecting at least one of a generated event and a received event, determining a corresponding program for the detected unhandled event, and if the window of the program corresponding to the unhandled event has floating display attributes, then driving the corresponding program to start running, and displaying the floating window of the corresponding program on a display screen.

### CROSS-REFERENCE TO RELATED APPLICATION(S)

The application claims the benefit under 35 U.S.C. §119(a) of a Chinese patent application filed on Jun. 7, 2013 in the State Intellectual Property Office and assigned Serial number 201310225900.1, the entire disclosure of which is hereby incorporated by reference.

### TECHNICAL FIELD

The present disclosure relates to the technical field of invoking programs. More particularly, the present disclosure relates to a method, an apparatus and a terminal device for invoking a program.

### BACKGROUND

According to the related art, terminals such as cell phones, tablet PCs, and the like, are popular in many aspects of people's life. Various mobile terminals are used for communications, watching videos, browsing on-line news, navigation, information sharing and reminding function, and the like. The functions of such mobile terminals are diverse and powerful.

Nowadays, in general, only a standard window of a running program in a terminal is displayed on the display screen during use of the terminal. The standard window is displayed in a manner of overspreading the display screen of the mobile terminal, thereby facilitating a subscriber to view content in the standard window, or facilitating information interaction performed by a subscriber with the running program through the standard window. Due to diverse functions of terminals, when a terminal runs a program, the terminal may also need to handle some other events. For example, when a subscriber is browsing on-line news, the subscriber is likely to receive a request for information sharing. If the subscriber intends to handle the function of information sharing, then the subscriber is required to exit the current program for browsing on-line news, and thereafter open the information sharing program.

According to the related art, events may include reminding events, information sharing, and the like that are preset by a subscriber, as well as events of reading information, events of positioning navigation and the like that are sent by the terminal operation system. When a terminal is running a program, if the operation system of the terminal is required to handle several events, the terminal usually handles these events respectively following the sequence that these events are monitored, then, after an event has been handled, the terminal is required to close a running program corresponding to that event, then, the terminal may start a program for handing the next event. As the operation flow of program switching is complicated, thus the terminal inefficiently handles multiple events.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method, an apparatus and a terminal device for invoking a program for solving the technical problem in the prior art, in which program switching are required to perform repeatedly for handling multiple events, and the operation flow of program switching is complicated and inefficient.

In accordance with an aspect of the present disclosure, a method for invoking a program is provided, The method includes detecting at least one of a generated event and a received event, determining a corresponding program for the monitored unhandled event, and if the window of the program corresponding to the unhandled event has floating display attributes, then driving the corresponding program to start running, and displaying a floating window of the corresponding program on a display screen.

In accordance with an aspect of the present disclosure, an apparatus for invoking a program is provided. The apparatus includes a monitoring module configured to detect at least one of a generated event and a received event, a determining module configured to determine a corresponding program for the detected unhandled event, a displaying module configured to drive the corresponding program to start running, to display the floating window of the corresponding program on a display screen, if the window of the program corresponding to the unhandled event has floating display attributes.

The present disclosure also provides a terminal device, wherein, the terminal comprises any of the above apparatuses for invoking a program.

In the aspects according to present disclosure, after monitoring a generated or received event, a corresponding process is determined for the monitored unhandled event, if the window of the program corresponding to the unhandled event has floating display attributes, then the corresponding program is driven to start running, and the floating window of the corresponding program is displayed on a display screen, so as to facilitate information interaction performed by subscribers with the corresponding program of the floating window, and to avoid complicated operations required by switching programs, thereby improving efficiency of subscribers on handling multiple events, simplifying switching operations of subscribers, and saving subscribers time.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flow chart of a first example of a method for invoking a program according to an embodiment of the present disclosure;

FIG. 2 is a flow chart of a second example of a method for invoking a program according to an embodiment of the present disclosure;

FIG. 3 is structural schematic diagram of a floating window of sending/receiving short messages in the second example according to an embodiment of the present disclosure;

FIG. 4 is structural schematic diagram of a data transmission floating window in the second example according to an embodiment of the present disclosure;

FIG. 5 is structural schematic diagram of an affair reminding floating window in the second example according to an embodiment of the present disclosure;

FIG. 6 is structural schematic diagram of a running program floating window in the second example according to an embodiment of the present disclosure;

FIG. 7 is a structural schematic diagram of the first example of an apparatus for invoking a program according to an embodiment of the present disclosure;

FIG. 8 is a structural schematic diagram of the second example of an apparatus for invoking a program according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be further understood that the terms “comprises/comprising” used in this specification specify the presence of stated features, integers, steps, operations, elements, and/or components, but do not preclude the presence or addition of one or more other features, integers, steps, operations, elements, components, and/or groups thereof. It should be understood that when a component is referred to as being “connected to” or “coupled to” another component, it can be directly connected or coupled to the other element or intervening elements may be present. In addition, the “connected to” or “coupled to” may also refer to wireless connection or couple. As used herein, the term “and/or” includes any and all combinations of one or more of the associated listed items.

Unless otherwise defined, all terms (including technical and scientific terms) used herein have the same meaning as commonly understood by one of ordinary skill in the art to which the present disclosure belongs. It shall be further understood that terms, such as those defined in commonly used dictionaries, should be interpreted as having a meaning that is consistent with their meaning in the context of the relevant art and will not be interpreted in an idealized or overly formal sense unless expressly so defined herein.

Those skilled in the art will understand that the term “terminal” used herein compasses not only electronic devices with a wireless signal receiver having no emission capability but also electronic devices with receiving and emitting hardware capable of carrying out bidirectional communication over the two-way communication link.

According to various embodiments of the present disclosure, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g. Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

According to various embodiments of the present disclosure, an electronic device may be configured to provide data communication, voice and data processing, an internet network/intranet access, a web browser, a notepad, a calendar, media (e.g., music/video) playback, and/or the like.

According to various embodiments of the present disclosure, an event may refer to a task, a request, an instruction, and/or the like for a terminal to start a corresponding program to implement a service function when the preset conditions are met.

According to various embodiments of the present disclosure, a source of events may include programs from the terminal per se or from a subscriber's instructions, and/or the like. According to various embodiments of the present disclosure, a frequency of occurrence of an event may refer to use frequency of events in per unit time, according to which the unit time may be 1 year, 1 month or 24 hours. According to various embodiments of the present disclosure, a display screen may be a touch screen having touch control function.

According to various embodiments of the present disclosure, two types of programs may be comprised in a practical application of a terminal. According to various embodiments of the present disclosure, a window of a first type of program has floating display attributes, and when the first type of program is running, a floating window of the program is displayed on the display screen, one or more floating windows may be displayed in the terminal, such that the overall or part of region of the floating window may be displayed on the display screen. According to various embodiments of the present disclosure, a window of a second type of program does not have floating display attributes, and the terminal can run a maximum of one of the second type of program.

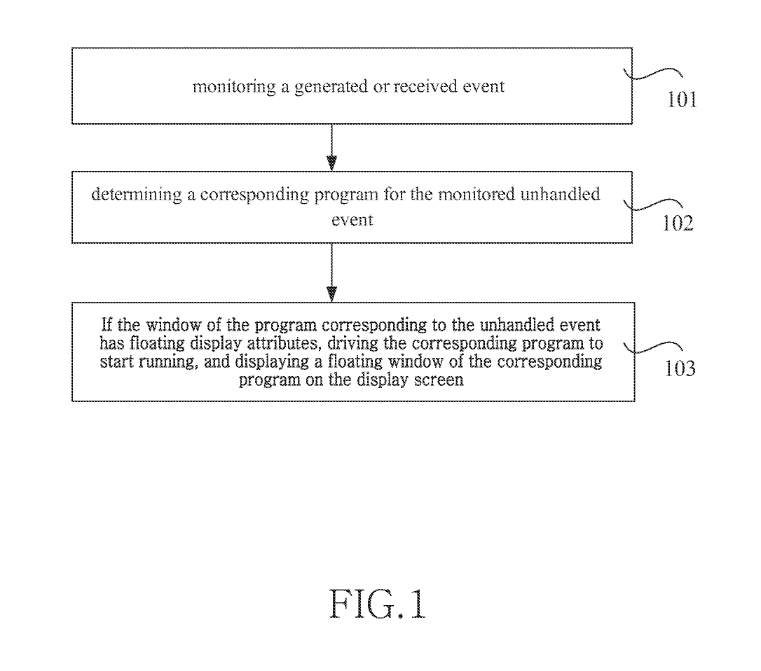

FIG. 1 is a flow chart of a first example of a method for invoking a program according to an embodiment of the present disclosure.

Referring to FIG. 1, the workflow of the method for invoking a program may comprise various operations.

At operation 101, a terminal may monitor a generated or received event. According to various embodiments of the present disclosure, an event may be generated from an application in the terminal or from the operation system when the preset conditions are met. According to various embodiments of the present disclosure, an event may be received from another external terminal or input by a subscriber to the terminal either.

According to various embodiments of the present disclosure, operation 102 may be performed upon monitoring (e.g., detecting) an event generated from the terminal or monitoring an event received by the terminal. For example, in response to monitoring (e.g., detecting) a generated or received event, the terminal may proceed to operation 102.

At operation 102, the terminal may determine a corresponding program for the monitored unhandled event. According to various embodiments of the present disclosure, a corresponding program is searched for the monitored unhandled event based on conditions such as function type of the unhandled event. If the unhandled event has a pre-designated program, then the pre-designated program is invoked. Alternatively, if the unhandled event does not have a pre-designated program, then a program for handling events of the function type is retrieved from the terminal, and a corresponding program capable of responding to the unhandled event is determined. Thereafter, the terminal may proceed to operation 103.

At operation 103, if the window of the program corresponding to the unhandled event has floating display attributes, then the terminal may drive the corresponding program to start running (e.g., the terminal may execute the corresponding program), and may display a floating window of the corresponding program on the display screen.

According to various embodiments of the present disclosure, if the window of the program corresponding to the unhandled event has floating display attributes, and if the corresponding program is actuated (e.g., executed), then the terminal may display a floating window of the corresponding program on the display screen, thereby enabling information interaction performed by a subscriber through the floating window. Further, the information interaction may include: reading content in the floating window, a subscriber's instruction input into the corresponding program through the floating window, and/or the like.

According to various embodiments of the present disclosure, after monitoring an event generated or received from a terminal, a corresponding process is determined for the monitored unhandled event. If the window of the program corresponding to the unhandled event has floating display attributes, then the corresponding program is driven to start running, and thereafter the floating window of the corresponding program is displayed on the display screen, so as to facilitate information interaction performed by subscribers with the corresponding program of the floating window. As a result, various embodiments of the present disclosure may avoid complicated operations associated with switching programs, thereby improving efficiency of subscribers on handling multiple events, and simplifying switching operations by subscribers. Accordingly, various embodiments of the present disclosure may save subscribers time.

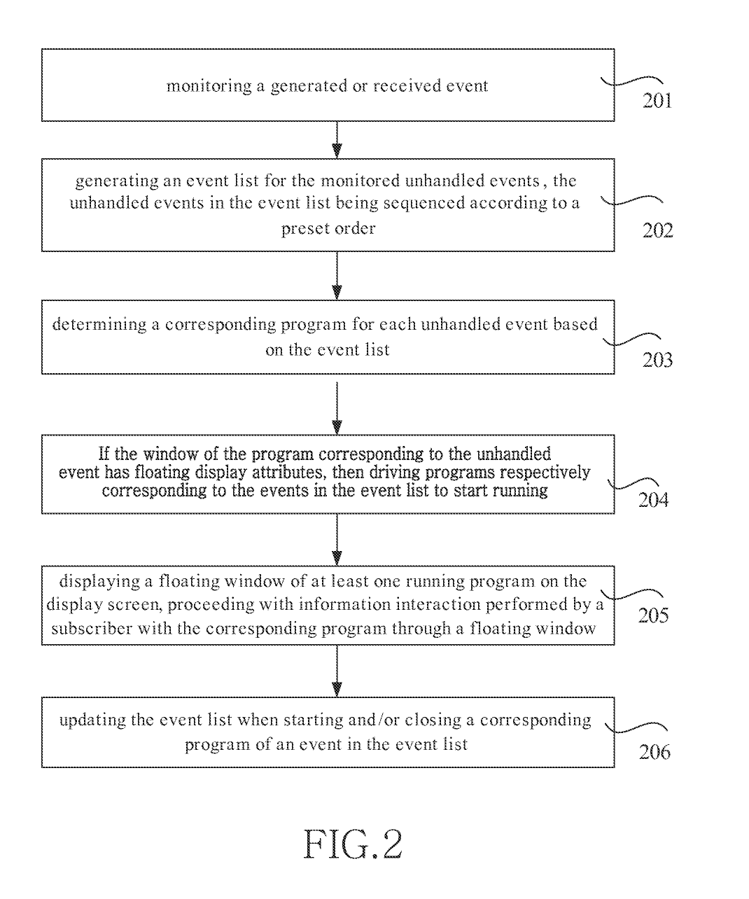

FIG. 2 is a flow chart of a second example of a method for invoking a program according to an embodiment of the present disclosure.

Referring to FIG. 2, the workflow of the method for invoking a program may comprise various operations.

At operation 201, a terminal may monitor a generated or received event. According to various embodiments of the present disclosure, if the terminal monitors (e.g., detects) an event generated from the terminal or monitors (e.g., detects) an event received by the terminal, then the terminal may proceed to operation 202.

At operation 202, the terminal may generate an event list for the monitored unhandled events. According to various embodiments of the present disclosure, the unhandled events in the event list may be sequenced according to a preset order.

According to various embodiments of the present disclosure, if at least two unhandled events exist, an event list may be generated for the monitored unhandled events. The unhandled events in the event list are sequenced according to a preset order. The unhandled events may be arranged according to the function type thereof, source of events, frequency of occurrence of events and/or priority of events, and/or the like. Further, the function type of events may include at least one of: a message type, a data transmission type, an affair reminding type, a navigation type, an application type, and/or the like. According to various embodiments of the present disclosure, events of the same function type may be sorted into a category. The unhandled events of the same category may be divided into groups. The unhandled events in the event list are sequenced.

According to various embodiments of the present disclosure, events of data transmission type may include Bluetooth data transmission, WiFi data transmission, wireless data transmission, and/or the like. Bluetooth data transmission, WiFi data transmission and wireless data transmission can be categorized in to a same category. According to various embodiments of the present disclosure, events of such a category can be divided into three groups that Bluetooth data transmission may be defined as the first group, WiFi data transmission may be defined as the second group, and wireless data transmission may be defined as the third group. Finally, all the unhandled events in the event list may be sequenced. The source of events may include an application or the operation system from the terminal per se, an external terminal, from a subscriber's input, and/or the like. In the event list, events from the same source may be divided into a same group, and all the data in the event list may be sequenced. In the event list, events may be sequenced according to frequencies of occurrence, according to priorities of events set beforehand (e.g., user preferences and/or settings, and/or the like), and/or the like. According to various embodiments of the present disclosure, the terminal may proceed to operation 203 after sequencing the unhandled events in the event list based on the preset order.

At operation 203, the terminal may determine a corresponding program for each unhandled event based on the event list. According to various embodiments of the present disclosure, a corresponding program that supports the function type of the event is searched based on conditions such as function type of an unhandled event. Thus, corresponding programs capable of responding to respective unhandled events in the event list may be searched to meet the requirement of a subscriber to handle such events (e.g., the unhandled events) in view of respective priorities thereof. According to various embodiments of the present disclosure, such searching and handling of the unhandled events may keep a subscriber from delaying or leaving events out of processing. According to various embodiments of the present disclosure, if multiple corresponding programs are identified for one event, all of the searched programs shall be provided to a subscriber for the subscriber's selection before performing. According to various embodiments of the present disclosure, after a corresponding program for each unhandled event is determined, the terminal may proceed to operation 204.

At operation 204, if the window of the program corresponding to the unhandled event has floating display attributes, then the terminal may drive programs respectively corresponding to the events in the event list to start running.

According to various embodiments of the present disclosure, if a window of a program corresponding to the unhandled event does not have floating display attributes, then the corresponding program of the event may be unable to display a floating window at runtime. For example, if a window of a program corresponding to the unhandled event does not have floating display attributes, then the window demonstrates that the corresponding program of the event cannot display a floating window at runtime. Under such a circumstance, a warning may be sent to a subscriber by means of an icon or a reminding signal and the like. If the subscriber is required to or otherwise desires to open a window to perform information interaction with the corresponding program, the subscriber may click the icon or reminding signal to start the corresponding program only after the subscriber interrupts a currently running program whose window has no floating display attributes. If windows of programs corresponding to the unhandled events have floating display attributes, then the corresponding programs of the events in the event list may be actuated in sequence based on the sequence of the events in the event list. Thereafter, the terminal may proceed to operation 205.

At operation 205, the terminal may display a floating window of at least one running program on the display screen, proceeding with information interaction performed by a subscriber with the corresponding program through a floating window.

According to various embodiments of the present disclosure, the terminal may display a floating window of at least one running program on the display screen. The subscriber may interact with information relating to the corresponding program through the floating window. For example, the event may be to receive a short message. For this event, when a subscriber invokes a program to open the short message for reading, content such as a picture, a text, an animation, and/or the like of the short message may be displayed on the screen in the form of a floating window.

If the window of the program corresponding to the event has floating display attributes, instead of displaying a floating window of the program, the terminal may display a shortcut icon of the corresponding program on the display screen. Thereafter, the terminal may display a floating window of the corresponding program once the terminal detects the shortcut icon being clicked by the subscriber. Alternatively, a reminding signal of the corresponding program may be displayed on the displayed screen, and then the terminal may displays a floating window corresponding to the reminding signal once the terminal detects the reminding signal being clicked by the subscriber. Alternatively, the terminal may display a floating window of the corresponding program directly on the display screen. Further, a reminding signal may comprise at least one of signals consisting of a light signal, an acoustic signal, a vibration signal, and/or the like.

Furthermore, when at least two floating windows are displayed on the display screen, the at least two floating windows are displayed based on a preset rule of displaying. For example, a floating window corresponding to an event with higher priority may be displayed on top, and a floating window corresponding to an event with lower priority may be displayed at the bottom. Further, the floating windows may be displayed being stacked in a staggered manner based on the sequencing result, and each of the floating windows may leave a part of area which is not completely covered by the other floating window. Accordingly, a subscriber may be capable of selecting a floating window through the uncovered area thereof, or may interact with information provided on the window through the uncovered area thereof.

If a subscriber interacts with the corresponding running program (e.g., interacts with information thereof) via a floating window, then, after the event is handled, the floating window may be closed, and the running program corresponding to the floating window may be closed either. Thereafter, the terminal may proceed to operation 206.

At operation 206, the terminal may update the event list when starting and/or closing a corresponding program of an event in the event list. For example, in response to executing or terminating a corresponding program of an event in the event list, the terminal may update the event list.

According to various embodiments of the present disclosure, after the event is handled, the terminal may no longer monitor the event. For example, the terminal may delete the event from the event list. The currently unhandled event may thereafter be sequenced again according to the preset order so as to update the event list. According to various embodiments of the present disclosure, in a practical application of the terminal, when the corresponding program of the event in the event list is started, the unhandled events in the event list may be sequenced again based on the preset order, so as to update the event list.

According to various embodiments of the present disclosure, in a practical application of the terminal, in the event that only one unhandled event is monitored, an event list may also be generated.

According to various embodiments of the present disclosure, the monitored events may be sequenced to generate an event list, and a corresponding program may be determined for each unhandled event in the event list. Thereafter, the corresponding programs of respective events may be actuated (e.g., executed), followed by displaying a floating window of at least one running program on the display screen, so as to facilitate a subscriber to interact with a program (e.g., information thereof) corresponding to the floating window in time. According to various embodiments of the present disclosure, complicated operations necessary for performing program switching repeatedly may be avoided, and efficiency on handling multiple events may be improved, thereby saving time for subscribers. The event list may be updated upon starting or closing corresponding programs of events in the event list, thereby effectively preventing a subscriber from delay in interacting with the running programs (e.g., information thereof) corresponding to the events, and thereby improving user experience.

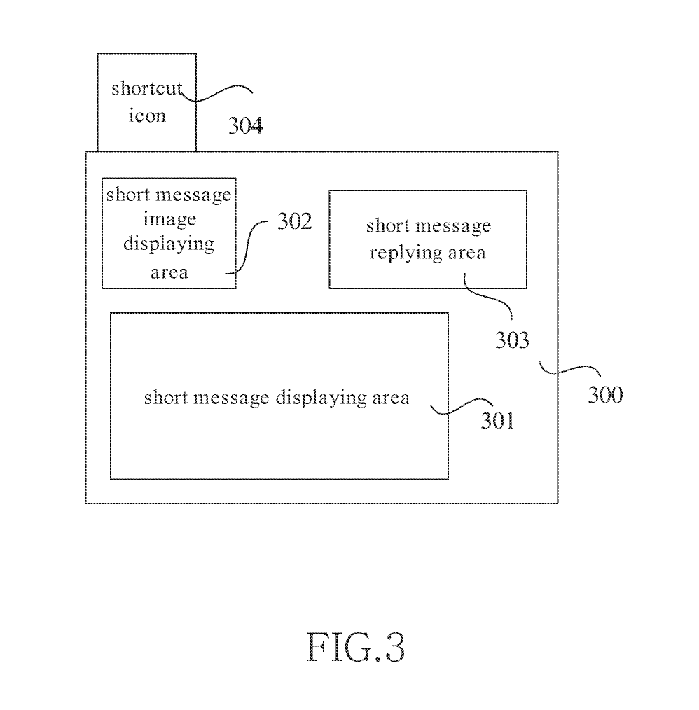

FIG. 3 is structural schematic diagram of a floating window of sending/receiving short messages in the second example according to an embodiment of the present disclosure.

Referring to FIG. 3, when handling an event of sending/receiving short messages, a short message floating window 300 may comprise a short message displaying area 301 (e.g., for displaying text information of a short message), a short message image displaying area 302 (e.g., for displaying pictures, animations, and/or the like of a short message), and a short message replying area 303 (e.g., for inputting content of a reply message). Further, a shortcut icon 304 of the short message floating window 300 may also be displayed on the display screen. According to various embodiments of the present disclosure, a subscriber may control the short message floating window 300 by controlling the shortcut icon 304. For example, a subscriber may perform operations of displaying, hiding, moving and closing on the short message floating window 300 via the shortcut icon 304, thereby facilitating the subscriber to control the floating window 300.

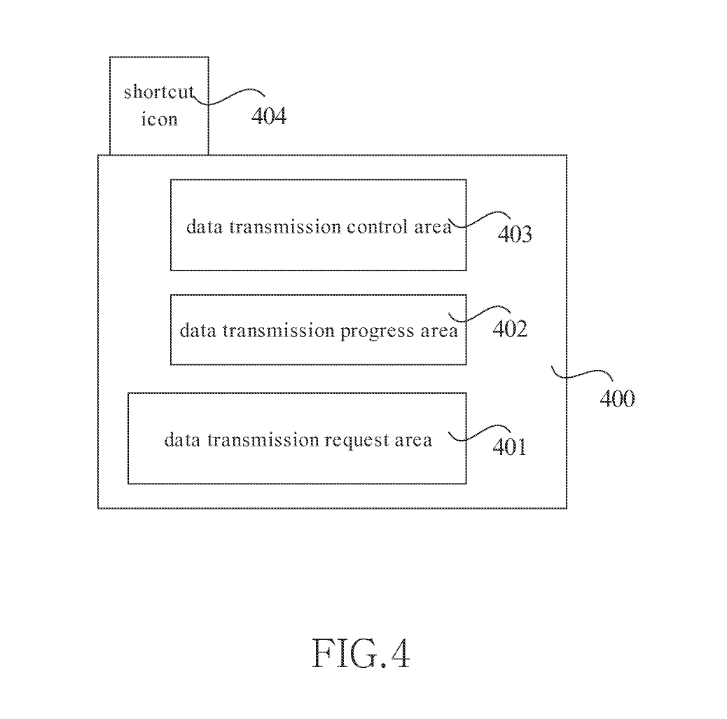

FIG. 4 is structural schematic diagram of a data transmission floating window in the second example according to an embodiment of the present disclosure.

Referring to FIG. 4, when handling an event of data transmission in this example, a data transmission floating window 400 may comprise data transmission request area 401, data transmission progress area 402 and data transmission control area 403. According to various embodiments of the present disclosure, the data transmission request area 401 may be used for displaying source, content, and/or the like of a data transmission request. According to various embodiments of the present disclosure, the data transmission progress area 402 may be used for displaying the progress of data transmission, for example, information such as volume percentage, speed, remaining time of data transmission, and/or the like. According to various embodiments of the present disclosure, the data transmission control area 403 may be used for controlling data transmission state, the data transmission state including: pause, interrupt, continuing with transmission, retransmission, and/or the like. According to various embodiments of the present disclosure, a shortcut icon 404 of the data transmission floating window 400 may also be displayed on the display screen. According to various embodiments of the present disclosure, a subscriber may control the data transmission floating window 400 by controlling the shortcut icon 404. For example, a subscriber may perform operations of displaying, hiding, moving and closing on the data transmission floating window 400 via the shortcut icon 404, thereby facilitating the subscriber to control the data transmission floating window 400.

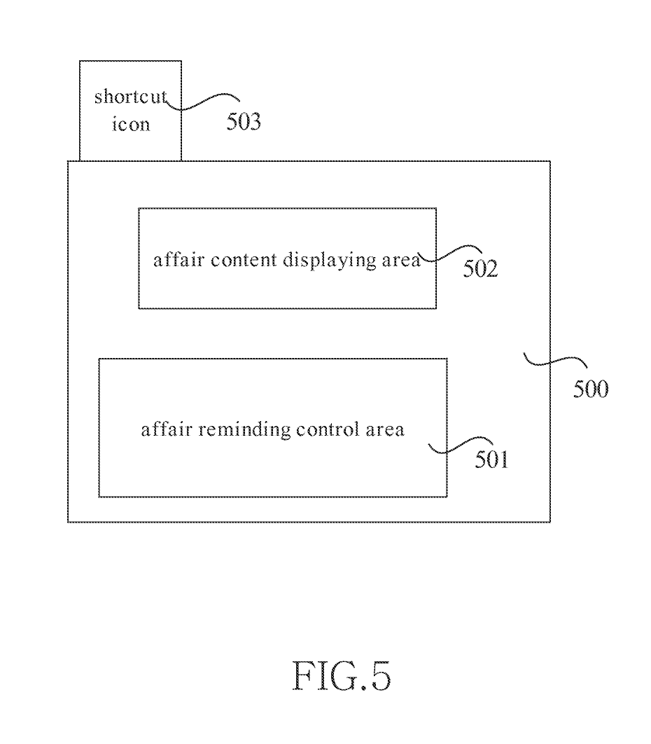

FIG. 5 is structural schematic diagram of an affair reminding floating window in the second example according to an embodiment of the present disclosure.

Referring to FIG. 5, when handling an event of affair reminding, an affair reminding floating window 500 may comprise an affair content control area 501 and an affair reminding display area 502. According to various embodiments of the present disclosure, the affair content displaying area 502 is used for displaying time of affair reminding, location of the affair and/or content of the affair, and/or the like. According to various embodiments of the present disclosure, the affair reminding control area 501 is used for controlling affair reminding state, the affair reminding state including interrupt, pause, continue and reset of time of reminding, and/or the like. A shortcut icon 503 of the affair reminding floating window 500 may also be displayed on the display screen. According to various embodiments of the present disclosure, the affair reminding floating window 500 may be controlled by controlling the shortcut icon 503. For example, a subscriber may perform operations of displaying, hiding, moving and closing on the data affair reminding floating window 500 via the shortcut icon 503, thereby facilitating the subscriber to control the affair reminding floating window 500.

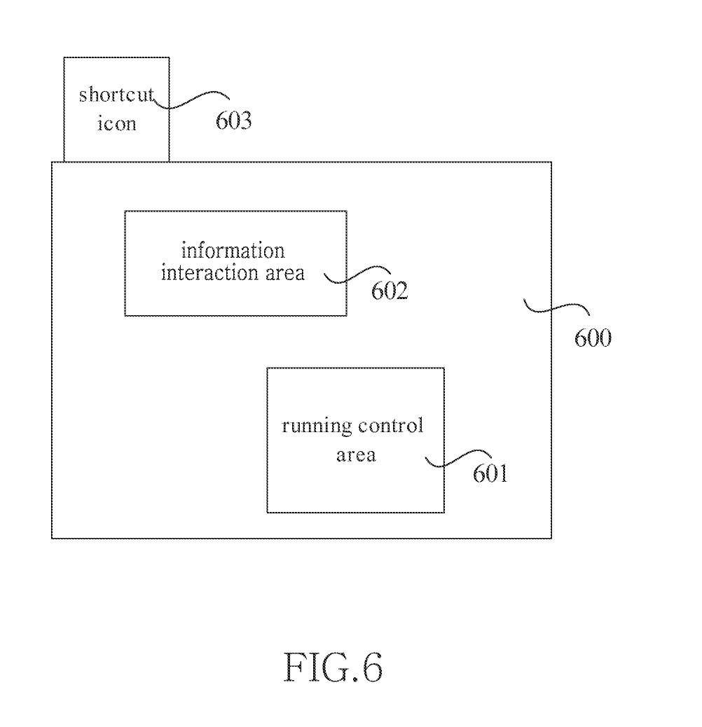

FIG. 6 is structural schematic diagram of a running program floating window in the second example according to an embodiment of the present disclosure.

Referring to FIG. 6, when handling an event of a running program, a running program floating window 600 may comprise a running control area 601 and an information interaction area 602. Further, a subscriber may interact with the running program (e.g., information thereof) through the information interaction area 602. According to various embodiments of the present disclosure, the subscriber may control running state of the running program through the running control area 601. Further, the running state of the running program may include an interrupt, a pause, a close, and/or the like. A shortcut icon 603 of the running program floating window 600 may also be displayed on the display screen. According to various embodiments of the present disclosure, a subscriber may control the running program floating window 600 by controlling the shortcut icon 603, a subscriber. For example, a subscriber may perform operations of displaying, hiding, moving, closing, and/or the like on the running program floating window 600 via the shortcut icon 603, thereby facilitating the subscriber to control the running program floating window 600.

Before displaying the floating windows as shown in FIGS. 3-6, a light signal, an acoustic signal and/or a vibration signal, and/or the like may be used provide an indication to a subscriber (e.g., to send a warning to a subscriber), so as to facilitate the subscriber to open a floating window in time, and to interact with a program (e.g., information thereof) corresponding to the floating window.

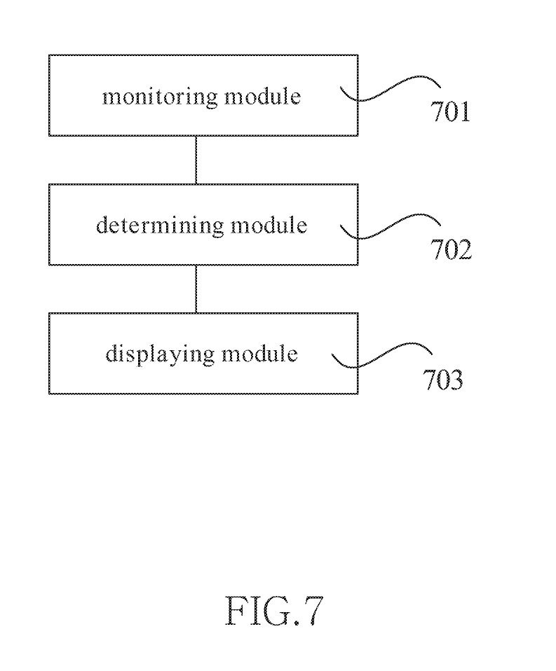

FIG. 7 is a structural schematic diagram of the first example of an apparatus for invoking a program according to an embodiment of the present disclosure.

Referring to FIG. 7, the apparatus for invoking a program may comprise a monitoring module 701, a determining module 702, and a displaying module 703. According to various embodiments of the present disclosure, the monitoring module 701 may be used for monitoring an event generated or received from the terminal. According to various embodiments of the present disclosure, the determining module 702 may be used for determining a corresponding program for monitored unhandled events. According to various embodiments of the present disclosure, the displaying module 703 may be used for driving a corresponding program to start running. Thereafter, the floating window of the corresponding program may be displayed on the display screen if the window of the program corresponding to the unhandled event has floating display attributes.

According to various embodiments of the present disclosure, after the monitoring module 701 monitors (e.g., detects) an event generated or received from a terminal, the determining module 702 may determine a corresponding process for the monitored unhandled event, if the window of the program corresponding to the unhandled event has floating display attributes, the displaying module may drive a corresponding program to start running. Thereafter, the floating window of the corresponding program may be displayed on the display screen, thereby facilitating subscribers to interact with the corresponding program (e.g., information thereof) of the floating window. According to various embodiments of the present disclosure, complicated operations required by switching programs may be avoided, thereby improving efficiency of subscribers on handling multiple events, simplifying switching operations for subscribers, and saving subscribers time.

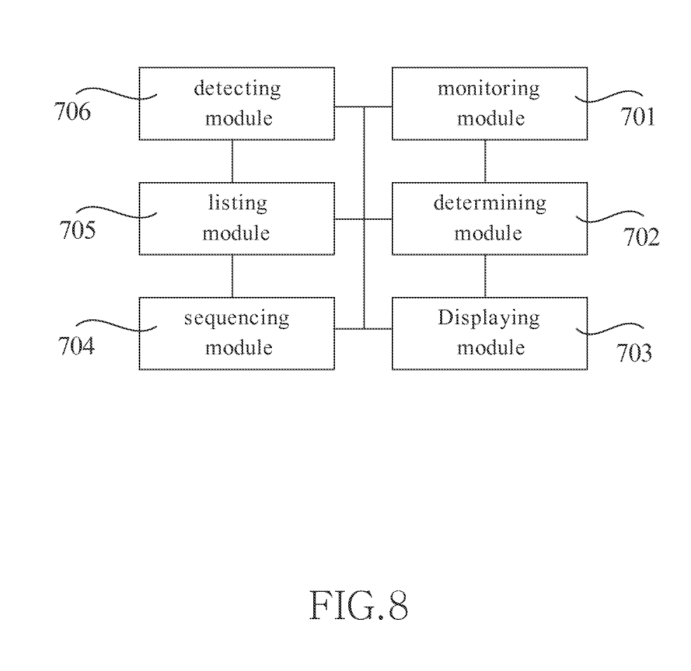

FIG. 8 is a structural schematic diagram of the second example of an apparatus for invoking a program according to an embodiment of the present disclosure.

Referring to FIG. 8, the apparatus for invoking a program may further comprise a sequencing module 704, a listing module 705, and a detecting module 706. As a shortcut icon of a corresponding program is displayed on the display screen, after detecting the shortcut icon being selected (e.g., clicked) by a subscriber, the detecting module 704 may inform (e.g., instruct) the displaying module 703 to display a floating window of the corresponding program, or as a reminding signal of a corresponding program is displayed on the display screen, after detecting the reminding signal being selected (e.g., clicked) by a subscriber, the detecting module 706 may inform (e.g., instruct) the displaying module 703 to display a floating window corresponding to the reminding signal. If at least two unhandled events exist, then the listing module 705 may generate an event list for the monitored unhandled events, and the sequencing module 706 may sequence the unhandled events in the event list according to a preset order. According to various embodiments of the present disclosure, the determining module may determine a corresponding program for each unhandled event in the event list. If at least two unhandled events exist, the listing module 705 may be used for generating an event list for the monitored unhandled events, the sequencing module 706 may be used for sequencing the unhandled events in the event list according to the preset order, and the determining module 702 may determine a corresponding program for each unhandled event based on the event list.

According to various embodiments of the present disclosure, in practical applications of the terminal, the listing module 705 may update the event list when a corresponding program of an event in the event list is started and/or closed. The sequencing module may arrange the unhandled events according to the function type thereof, source of events, frequency of occurrence and/or priority of events. For example, the sequencing module 706 may sort the events according to function type of the unhandled events, then sorted unhandled events of the same type into groups, followed by sequencing respective unhandled events in the event list.

Further, if the unhandled event has a pre-designated program, then the determining module 702 may invoke the pre-designated program. If the unhandled event does not have a pre-designated program, then the determining module 702 may retrieve a program from the terminal, and may determine a program capable of responding to the unhandled event. For example, the determining module 702, based on the function type of the event, may search a corresponding program that supports the function type; in addition, once the determining module 702 identifies multiple corresponding programs, the determining module 702 may provide the multiple programs for a subscriber's selection, before driving a corresponding program to start running. When displaying at least two floating windows on the display screen, the displaying module 703 may display said at least two floating windows being stacked in a staggered manner based on a preset displaying rule.

Various embodiments of the present disclosure further provide a terminal device comprising the apparatus for invoking a program from a terminal as shown in FIG. 7 or FIG. 8. The apparatus for invoking a program may comprise a monitoring module 701, a determining module 702 and a displaying module 703. The monitoring module 701 may be used for monitoring (e.g., detecting) an event generated or received from a terminal. The determining module 702 may be used for determining a corresponding process for the monitored unhandled event. The displaying module 703 may be used for driving a corresponding program to start running, then displaying the floating window of the corresponding program on the display screen in the case the window of the program corresponding to the unhandled event has floating display attributes, thereby facilitating a subscriber to interact with the corresponding program (e.g., information thereof) of the floating window. According to various embodiments of the present disclosure, complicated operations required by switching programs may be avoided, thereby improving efficiency on handling multiple events, and saving subscribers time.

A person skilled in the art can understand that the present disclosure may involve devices for carrying out one or more the operations as described in the present application. The devices can be specially designed and manufactured as required, or can include well known equipment in a general-purpose computer which stores programs that are selectively activated or reconstructed. Computer programs as such can be stored in non-transitory device-readable media such as a non-transitory computer-readable storage media or in any type of medium suitable for storing electronic signaling and respectively coupled to a bus. The non-transitory computer readable medium includes but not limited to any type of disk (e.g., including floppy disk, hard disk, optical disk, CD-ROM, and magneto optical disk, and/or the like), Random Access Memory (RAM), Read Only Memory (ROM), Electrically Programmable ROM (EPROM), Electrically Erasable ROM (EEROM), Electrically Erasable Programmable ROM (EEPROM), flash memory, magnetic card, optical line card, and/or the like. Readable media include any mechanism for storing or transmitting information in a device-readable form such as computer-readable form. For instance, readable media include Random Access Memory (RAM), ROM, magnetic disk storage medium, optical storage medium, flash memory apparatus, signals (such as carriers, infrared signals, digital signals) that travel in an electrical, optical, acoustic, or other form and/or the like.

It should be understood by a person skilled in the art that computer program instructions can be used to realize these structural diagrams and/or each block in block diagrams and/or flow charts as well as a combination of these structural diagrams and/or blocks in the block diagrams and/or flow diagrams. These computer program instructions can be provided to general purpose computers, special purpose computers or other processors of programmable data processing means to produce a machine, so that the instructions are executed by the computers or the processors of programmable data processing means to create a designated method for effecting the structural diagram and/or a block or blocks of block diagrams and/or flow diagrams.

A person skilled in the art can understand that the operations, the methods, the operations in the flows, the measures, the schemes discussed in the present disclosure can be replaced, changed, combined or deleted. Further, the operations, the methods, the other operations in the flows, the measures, the schemes discussed in the present disclosure can also be replaced, changed, rearranged, combined or deleted. Further, related arts having the operations, the methods, the other operations in the flows, the measures, the schemes discussed in the present disclosure can also be replaced, changed, rearranged, combined or deleted.

The descriptions hereinabove are only part of various embodiments of the present disclosure. It should be pointed out that to a person skilled in the art, under the circumstance without deviating from the principle of the present disclosure, he can also make several improvements and modifications, where these improvements and modifications should also be deemed falling within the protection scope of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for invoking a program on a terminal, the method comprises:
detecting at least one of a generated event and a received event;
determining a corresponding program for the detected unhandled event; and
if the window of the program corresponding to the unhandled event has floating display attributes, then driving the corresponding program to start running, and displaying a floating window of the corresponding program on a display screen.

2. The method of claim 1, wherein the determining of the corresponding program for the monitored unhandled event, comprises:
if the unhandled event has a pre-designated program, then invoking the pre-designated program; and
if the unhandled event does not have a pre-designated program, then retrieving a program from the terminal, and determining a corresponding program capable of responding to the unhandled event.

3. The method of claim 2, wherein the determining of the program capable of responding to the unhandled event, comprises:
according to a function type of the event, searching a corresponding program that supports the function type; and
if multiple programs are identified by the search for a corresponding program, then providing a subscriber with the multiple programs for subscriber selection before driving the corresponding program to start running.

4. The method of claim 1, wherein the displaying of the floating window of the corresponding program on the display screen, comprises:
displaying a shortcut icon of the corresponding program on the display screen;
displaying a floating window of the corresponding program after detecting the shortcut icon being selected by a subscriber,
displaying a reminding signal of the corresponding program on the display screen;
displaying a floating window corresponding to the reminding signal after detecting the reminding signal being selected by a subscriber, and
displaying the floating window of the corresponding program directly on the display screen.

5. The method of claim 1, wherein the determining of the corresponding program for the monitored unhandled event, comprises:
if at least two unhandled events exist, generating an event list for the detected unhandled events, the unhandled events in the event list being sequenced according to a preset order; and
determining a corresponding program for each unhandled event based on the event list.

6. The method of claim 5, wherein unhandled events in the event list being sequenced according to the preset order, comprises:
arranging the unhandled events according to at least one of a function type thereof, a source of events, a frequency of occurrence, and a priority of events.

7. The method of claim 6, wherein the unhandled events in the event list being sequenced according to the preset order, comprises:
sorting the events according to a function type of the unhandled events;
dividing unhandled events of the same type into groups; and
sequencing respective unhandled events in the event list.

8. The method of claim 3, wherein the function type of events including at least one of:
a message type, a data transmission type, an affair reminding type, a navigation type, and an application type.

9. The method of claim 8, wherein a floating window for handling events of the message type comprises an image displaying area, a message displaying area, and a message replying area,
wherein a floating window for handling events of the data transmission type comprises a data transmission request area, a data transmission progress area, and a data transmission control area,
wherein a floating window for handling events of the affair reminding type comprises an affair content displaying area and an affair reminding control area, and
wherein a floating window for handling events of the application type comprises an information interaction area and a running control area.

10. The method of claim 1, wherein the displaying of the floating window of the corresponding program on the display screen, comprises:
when displaying at least two floating windows on the display screen, displaying said at least two floating windows being stacked in a staggered manner based on a preset displaying rule.

11. The method of claim 5, further comprising:
updating the event list when a corresponding program of an event in the event list is at least one started and closed.

12. An electronic device, the electronic device comprises:
a monitoring module configured to detect at least one of a generated event and a received event;
a determining module configured to determine a corresponding program for the detected unhandled event;
a displaying module configured to drive the corresponding program to start running, to display the floating window of the corresponding program on a display screen, if the window of the program corresponding to the unhandled event has floating display attributes.

13. The electronic device of claim 12, wherein the determining module is configured to,
if the unhandled event has a pre-designated program, invoke the pre-designated program; and
if the unhandled event does not have a pre-designated program, retrieve a program from the terminal, and determine a program capable of responding to the unhandled event.

14. The electronic device of claim 13, wherein the determining module is configured to,
according to a function type of the event, search a corresponding program that supports the function type;
if multiple programs are identified by the search for a corresponding program, provide a subscriber with the multiple programs for subscriber selection before driving the corresponding program to start running.

15. The electronic device of claim 12, further comprising:
a detecting module;
wherein a shortcut icon of the corresponding program is displayed on the display screen, after detecting the shortcut icon being selected by a subscriber, the detecting module informs the displaying module to display a floating window of the corresponding program, and
wherein a reminding signal of the corresponding program is displayed on the display screen, after detecting the reminding signal being selected by a subscriber, the detecting module informs the displaying module to display a floating window corresponding to the reminding signal.

16. The electronic device of claim 12, further comprising:
a listing module;
a sequencing module;
wherein, if at least two unhandled events exist, then the listing module generates an event list for the detected unhandled events, and the sequencing module sequences the unhandled events in the event list according to a preset order,
wherein the determining module determines a corresponding program for each unhandled event based on the event list.

17. The electronic device of claim 16, wherein the sequencing module is configured to,
arrange the unhandled events according to at least one of a function type thereof, a source of events, a frequency of occurrence, and priority of events.

18. The electronic device of claim 17, wherein the sequencing module is configured to,
sort the events according to function type of the unhandled events,
divide unhandled events of the same type into groups, and
sequence respective unhandled events in the event list.

19. The electronic device of claim 12, wherein the displaying module is configured to,
when displaying at least two floating windows on the display screen, display said at least two floating windows being stacked in a staggered manner based on a preset displaying rule.

20. The electronic device of claim 12, wherein the listing module is further configured to,
update the event list when a corresponding program of an event in the event list is at least one of started and closed.
